(19) United States
(12) Patent Application Publication
(10) Pub. No.: US 2017/0171515 A1
(43) Pub. Date: Jun. 15, 2017

(54) See What's Behind You (SWBY - pronounced "Swee-Bee")

(71) Applicants: Toni Yvette Pender, Alpharetta, GA (US); Christopher Anthony Spencer, Kennesaw, GA (US)

(72) Inventors: Toni Yvette Pender, Alpharetta, GA (US); Christopher Anthony Spencer, Kennesaw, GA (US)

(21) Appl. No.: 14/885,982

(22) Filed: Dec. 14, 2015

(51) Int. Cl. H04N 7/18; H04N 5/225; A42B 1/22; H04N 5/232; A42B 1/24

(52) U.S. Cl. CPC H04N 7/185; H04N 5/23238; A42B 1/245; A42B 1/22; H04N 5/2252

(57) ABSTRACT

See What's Behind You is a security technology device that gives people the ability to see and monitor what's coming behind them at a 180 degree rear view angle whether it's human or animal while facing forward. A battery operated camera system is connected by video cable to a screen and memory card that captures recorded activities in real time video.

The technology is incorporated in any head gear such as caps, helmets and eyewear including sun visors.

It's used during personal outdoor activities that bring concern and it's used in professional industries such as branches of Homeland Security to enhance safety with rear vision. It exposes elements of surprise attacks giving people the advantage to conspicuously judge the situation, respond to it quickly and appropriately while lessening their chance of becoming a victim, the real time video images can be used to file a police report.

### CROSS-REFERENCE TO A RELATED APPLICATION

We claim benefit of Provisional Patent Application No. 62/060,608 filed Oct. 7, 2014.

### BACKGROUND

We all deserve the ability to take control of our personal safety while enjoying the benefits of outdoor activities including work. Most of us have safe guards in place at our homes whether it's security systems, camera's policing the grounds and/or even a weapon of choice. We sometimes carry protection with us in our cars. The company's we work for have internal safe guards in place to protect the employees as well as the premises including company assets.

All over America, there are large communities of people who enjoy being outdoors doing fun activities or keeping fit while reaping the benefits of fresh air. Whether your outdoor activity is for fun, work, exercise or play, it's a sure way to relax the mind and the body and for those who are serious about outdoor fitness realize the potential risk of assaults that could occur and have occurred. Many groups have formed message boards and websites offering safety tips that should be followed if anyone intends to jog, run or walk outdoors alone or in small groups. Every day, all over America, you hear the news about someone somewhere who has been killed, violated or attacked by a human or an animal because they did not see their attacker coming!

In today's society, where, when & how are important questions to ask yourself when it comes to safe guarding yourself and your loved ones; Where are you going, when will you leave, when do you plan to return and how will you get there? Family members and loved ones need answers to these questions in advance so that anything outside of the answer you give them will be an alert that something could be worth checking out . . . why?

While the majority of us are law abiding and contributing members of society, a very few of us are not. Where you live, work and play, you must be aware of your surroundings at all times and have the ability to take control of your own personal safety. Let's say you're prepared to run today, you have on the right running shoes and attire and you even have your head-phones to listen to your favorite music while you exercise. You leave the safety of your home without a second thought that you might encounter someone waiting to make you their victim. You've heard the news!

Most joggers who have been violated or assaulted will say “I never saw it coming” and that is because many assailants came up on the victim from behind or outside their peripheral vision. Unless they are constantly turning around and looking behind them, how could they see it coming? Even if you are armed with pepper spray, or your safety product of choice, how can you act on what you can't see coming?

When jogging, strolling, running errands, walking the pet or any activity that brings concern about your safety, what product in the market gives you the advantage to see behind you while facing forward, assess potential danger and respond to it quickly and appropriately and capture recorded activities in real time video?

See What's Behind You (SWBY—pronounced “Swee-Bee”) is your answer because SWBY is technology incorporated in any head gear such as caps, helmets and eyewear that has a camera/lens system connected by cable to a screen/monitor, is battery operated, it allows you to see what's coming behind you while facing forward and it captures recorded activities in real time video. SWBY is designed to give you the ability to see what's behind you at a 180 degree rear view angle while facing forward. Your normal vision allows you to see what's in front of you as well as peripherally and by wearing SWBY, you could have total vision at 360 degrees facing forward. SWBY gives you the ability to take control of your own personal safety, see trouble coming, monitor any activity approaching you from the rear whether it's human or animal and have access of recorded activities in real time video.

### BRIEF SUMMARY OF THE INVENTION

See What's Behind You (SWBY—pronounced “Swee-Bee”) is a personal security technology product that will change the way people look at and respond to their own personal security. People will no longer be startled by what they didn't see coming because SWBY will empower people during daily activities such as walking, jogging, biking, hiking, running errands or any outdoor activity, to monitor what's behind them at a 180 degree rear view angle whether it's human or animal while facing forward. SWBY can be used in professional industries such as Security, Law Enforcement, Military, Transportation and Construction. SWBY is technology that can be incorporated with any head gear including caps, helmets and eyewear that has a camera/lens system connected by cable to a screen/monitor, is battery operated, it allows you to see what's coming behind you while facing forward and it captures recorded activities in real time video. When used properly, SWBY exposes the element of a surprise attack giving people the advantage to monitor and conspicuously judge the situation, respond to it quickly and appropriately while lessening their chance of becoming a victim and SWBY captures real time video images in the event you want to file a police report.

### BRIEF DESCRIPTION OF THE DRAWINGS

An understanding of the invention will be explained in more detail from the reading of the detailed description and in conjunction with the accompanying drawing figures, in which:

FIG. 1 is the front view perspective of a baseball cap incorporating cap design and features to support the invention screen/monitor component;

FIG. 2 is the rear view perspective of a baseball cap incorporating cap design and features to support the invention camera/micro-lens location through an opening in the rear of the cap and to create a secure fit of the cap to the head;

FIG. 3 is the inside and under-side perspective of a baseball cap incorporating the baseball cap's design and features for housing, protecting and supporting the security technology device invention components as well as user comfort;

FIG. 4 is the design diagram of the security technology device including components and features without the cap.

### DETAILED DESCRIPTION

In the following detailed description and drawings, the invention according to the teaching for this application in the form of a baseball cap and will be described as an indication of one of its uses. It should be noted that although only a baseball cap is described for the teaching of this application, See What's Behind You (SWBY—pronounced “Swee Bee”) is technology that can be incorporated with any head gear such as caps, helmets and eyewear including sun-visors. It should be further noted that the drawings are diagrams to illustrate basic design and features of the invention specifically for a cap and the security technology device does not limit design improvements, uses and capacity. Also, the internal construction details of the security technology device, including the camera/micro-lens component, the video cable and screen/monitor component, software and protocol structure of the components will not be described in detail since such technology is generally well known among electrical engineers and other professionals of the art.

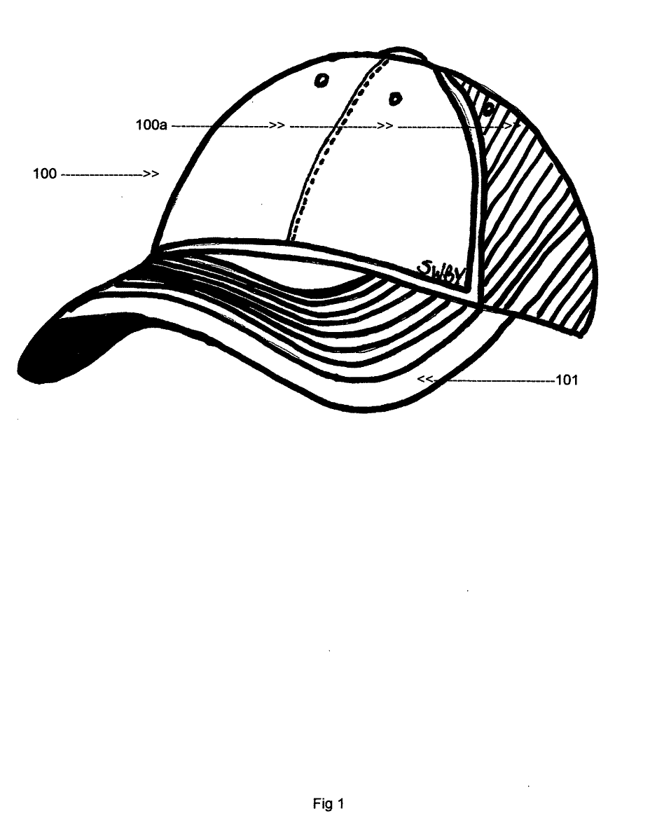

The baseball cap 100 front view is illustrated in FIG. 1. The baseball cap 100 is a low profile cap made from 100% cotton, has a deep rounded crown 100a made with six 6 panels, each with an eyelet and all 6 panels come together by a button at the top of the crown. The baseball cap 100, deep rounded crown 100a has 2 front panels, 2 rear panels, 1 panel on the right and 1 panel on the left. The baseball cap 100 has a 4.25 inch peak/brim/bill 101 that is slightly angled down at eye-level yet offers unobstructed sight and protection of the face and eyes from harmful sun rays. The baseball cap 100 along with the deep rounded crown 100a and the 4.25 inch peak/brim/bill 101 is constructed with durability, reinforced stitching and is one size fits all.

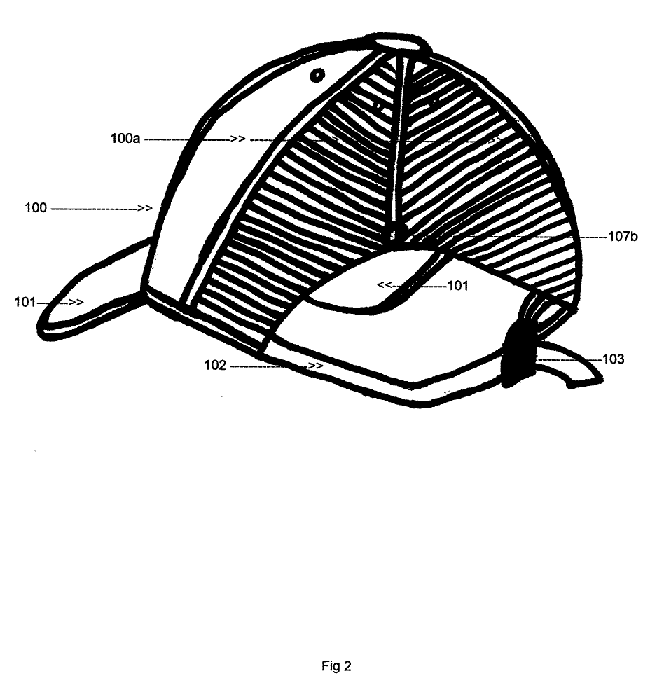

The baseball cap 100 rear view is illustrated in FIG. 2. The baseball cap 100 rear view shows a left and right corner glimpse of the 4.25 inch peak/brim/bill 101 and the left lateral and rear view of the deep rounded crown 100a reveals the left side panel and 2 rear panels. The bottom of the 2 rear panels of the deep rounded crown 100a has an opening for the location of the camera/micro-lens 107a and the opening gives the appearance of an eyelet previously mentioned in baseball cap 100 FIG. 1. The baseball cap 100 rear view, in the same illustration also shows the rear adjustable strap 102 that allows the cap to be adjusted to fit snug and the metal clasp 103 allows for a secure and tight fit allowing one size fits all as described in FIG. 1 description of baseball cap 100.

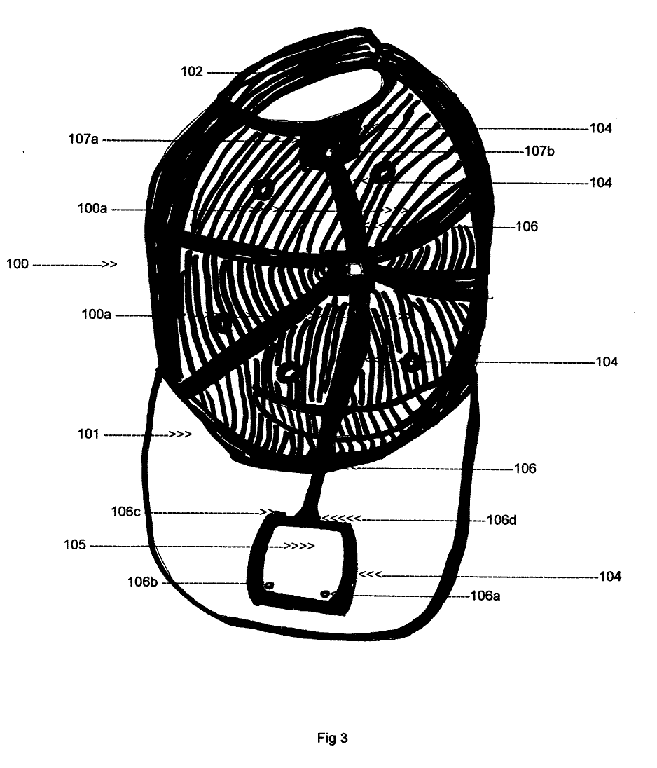

The baseball cap 100 inside and under-side view is illustrated in FIG. 3. FIG. 3 captures where the invention is incorporated in one of its uses as a cap and how the invention is securely installed underneath and inside the baseball cap 100 starting from the middle end of the 2 rear panels through the center point of the right and left panels including the middle of the front 2 panels of the deep rounded crown 100a and continuing on to the anterior center of the 4.25 inch peak/brim/bill 101. FIG. 3 reveals the location of the camera/micro-lens housing component 107a which in size is the perimeter of a quarter and houses the battery, the USB port and encases the camera/micro-lens 107b both seated underneath and between the bottom part of the 2 rear panels of the baseball caps 100 deep rounded crown 100a just below the rear adjustable strap 102. FIG. 3 also reveals the location of the screen/monitor component 105 seated underneath the anterior middle part of the 4.25 inch peak/brim/bill 101 which is designed as a long brim to accommodate and support the 2-3 inch by 2-4 inch screen/monitor component 105. Note the screen/monitor component 105 houses the on/off button 106a, the battery indicator light 106b, and the memory card release button 106c, all seen in the current view. It should be noted that the memory card release button 106c seen in FIG. 3 will release the memory card from the screen/monitor component 105 for insertion into a computer to review captured recorded activities in real-time video. FIG. 3 further illustrate the location of the video cable 106 seated underneath and extending from the top of the screen/monitor component 105 up the middle of the baseball cap's 100 deep rounded crown 100a and ending at the bottom of the camera/micro-lens housing component 107a creating the connection between both the camera/micro-lens housing component 107a and the screen/monitor component 105. FIG. 3 illustrates a custom-made moisture protected pocket with reinforced stitching 104 sewn to the inside of the cap from the rear panels continuing through the center of the left and right panels including the middle of the 2 front panels underneath the deep rounded crown 100a and continuously extending down to the screen/monitor component 105 allowing housing, moisture protection, user comfort, a secure fit and support of the invention's camera/micro-lens housing component 107a including the camera/micro-lens 107b, the entire length of the video cable 106 and the screen/monitor component 105. Finally, FIG. 3 shows a location where the video cable 106 can be unplugged 106d from the screen/monitor component 105 and removed from the custom moisture protected pocket 104.

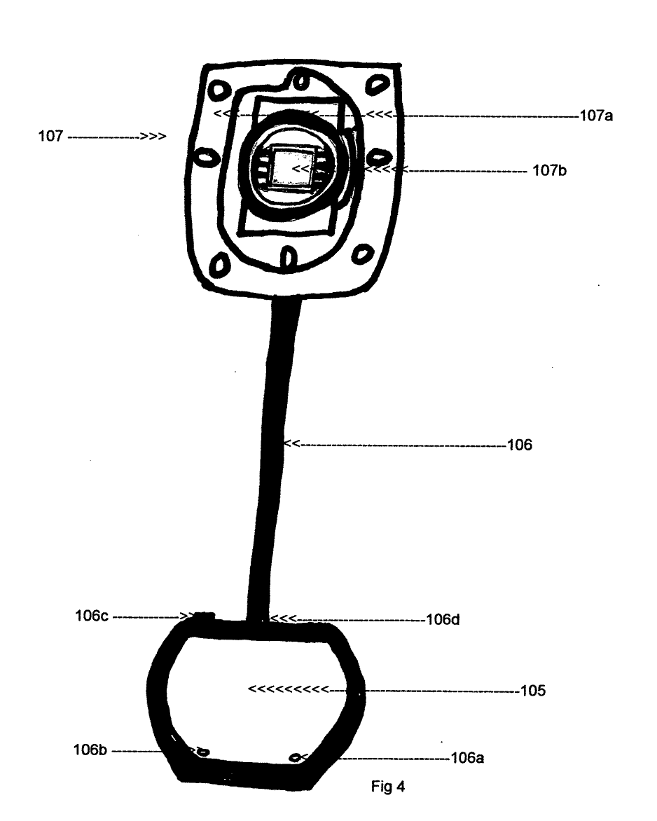

The engineering technology, protocol structure and construction of the internal components and software will not be demonstrated in the invention teaching in FIG. 4 in detail since such technology is generally well known among professionals; however, the security technology device 107 including its basic design of the components and features without the cap is illustrated in FIG. 4. The security technology device 107 shows the camera/micro-lens housing component 107a which in size is the perimeter of a quarter, houses the battery with battery life of 2-3 hours per charge, a USB port, has 1080p progressive scan capability or better, and it encases the camera/micro-lens 107b which has light sensitivity. FIG. 4 security technology device 107 demonstrates the video cable 106 extending from the bottom of the camera/micro-lens housing component 107a down to the top connection point of the screen/monitor component 105 creating the connection between both the camera/micro-lens housing component 107a and the screen/monitor component 105. The screen/monitor component 105 features include 2-3 inch by 2-4 inch video screen which houses the on/off button 106a, the battery indicator light 106b, and the memory card release button 106c, all seen in the current view. It should be noted that the memory card release button 106c will release the memory card from the screen/monitor component 105 for insertion into a computer to review captured recorded activities in real-time video. The current view shows where the screen/monitor component 105 can be unplugged 106d from the video cable. The screen/monitor component 105 is high resolution display with the capability to show human/animal activity clearly 8-10 feet away with at least 320 by 480 pixels, its refresh rate is at least 3 hertz per second or greater.

It must be noted that only a baseball cap is described for the teaching of this application, however, See What's Behind You (SWBY—pronounced “Swee Bee”) is personal security technology that can be incorporated with any head gear such as caps, helmets and eyewear including sun-visors and can be used for both personal use such as walking, strolling, jogging, running errands, biking, hiking and professional use such as Security, Law Enforcement, Construction, Military and Transportation.

The teaching of the present application has been described in detail for illustrative purposes, yet, it must be understood that variations can be made by those skilled in the art such as engineers without departing from the scope of the teaching of this application.

For the teaching of this application, it must be further noted that the drawings are diagrams to illustrate basic design and features of the invention including the cap and the security technology device and does not limit design improvements, uses and capacity. Also, the internal construction details of the components, software and protocol structure of the camera/micro-lens component, video cable and screen/monitor component will not be described in detail since such technology is generally well known among electrical engineers and other professionals of the art.

Regarding the teaching of this application security technology device incorporated in a cap and its use, See What's Behind You (SWBY—pronounced “Swee-Bee”) comes complete with a cap designed with a custom moisture protected pocket that houses, support and protect the security technology device and is equipped with camera/micro-lens component, video cable, screen/monitor component and memory card, rechargeable battery, USB cable and charger and removable covers to protect the camera/micro-lens and screen/monitor when not in use. The invention is simply worn as you would any baseball cap. 1^{st} turn the on/off button on located at the bottom of the screen/monitor, at full charge the battery indicator light is green and is designed to last 2-3 hours. Next, press the memory card release button at the top of the screen to ensure that the memory card is inserted properly. Place the cap on your head as you would any baseball cap with the deep rounded crown fitted securely; adjusting the adjustment strap as needed for a secure fit and securing the peak/brim/bill to face forward.

The peak/brim/bill is designed to fit slightly angled down at eye-level while offering unobstructed sight and protection of the face and eyes from harmful sun rays. You will look forward and slightly up to view video activity on your screen/monitor. You should see a full forward image view with clarity and high resolution display of real time activity of what's going on behind you at a 180 degree rear view angle while facing forward. Any movement or activity on the screen must be carefully monitored and acted on accordingly. Always Be Alert and Prepared when it comes to your personal safety and the safety of your loved ones! Begin your outdoor activity.

When used properly, See What's Behind You (SWBY—pronounced “Swee-Bee”) exposes the element of a surprise attack giving people the advantage to monitor and conspicuously judge the situation, respond to it quickly and appropriately while lessening their chance of becoming a victim and it captures real time video images in the event you want to file a police report.

At the end of your activity, turn off your See What's Behind You (SWBY—pronounced “Swee-Bee”), plug your USB power cord to your battery port located on the side of the camera/micro-lens housing component and charge it to full power before your next use.

Remove your memory card by pressing the memory card release button located at the top of your screen and insert it in your computer to review your activities. Remember to protect your screen and lens from scratches with your removable screen and lens cover provided with your product when not in use.

1. A Security Technology device incorporated in a custom fitted cap is designed to give the user the ability to see what's behind them at a 180 degree rear view angle whether it's human or animal while facing forward and captures recorded activities in real time video, it constitutes:
a 1080p progressive scan capability or better camera/micro-lens system with light sensitivity housed in a camera/micro-lens component smaller than the perimeter of a quarter and the component contains a battery with a battery life of 2-3 hours per charge, a battery port, a video cable;
a video cable connects at the bottom end of the camera/micro-lens component that extends in length to plug into the top of the screen/monitor component at plug-in site allowing the video cable internal components influence on-screen functionality and creates the connection between the camera/micro-lens component and the screen/monitor component;
a screen/monitor component with a screen size of 2-3 inches by 2-4 inches, is connected to the lower end of the video cable at the plug-in site offering high resolution display, showing human/animal activity clearly 8-10 feet away with 320 by 480 pixels, its refresh rate is 40 hertz (at least H3 per second or greater), it houses a memory card that captures recorded activities in real time video, an on/off button, a battery indicator light, a memory card release button and memory card exit site, a connection/plug-in point for the video cable;
a USB cable, charger, removable screen and lens cover, a rechargeable battery that last 2-3 hours when fully charged, a cap with custom designed pocket to house the security technology device including user instructions are some items included with the packaging;
a low profile baseball cap made from 100% cotton, has a deep rounded 6 panel crown each with an eyelet and all 6 panels come together with a button at the top of the crown, a custom designed peak/brim/bill is 4.25 inches in length, slightly angled down at eye-level offering unobstructed sight and protection of the face and eyes from harmful sun rays, a rear adjustable strap and metal clasp makes it one size fits all and is constructed with durability, reinforced stitching;
a custom moisture protected pocket with reinforced stitching is sewn inside the baseball cap to provide user comfort and to house, protect and support the security technology device.

2. A Security Technology device according to claim 1 can be incorporated with any head gear such as caps, helmets and eyewear including sun-visors, the baseball cap is used as an indication of one Of its uses in this teaching and comes with a custom design moisture protected pocket sewn inside the middle of the cap with reinforced stitching from the bottom portion of the rear panel through the middle right and left panels and the front panels to the anterior middle of the caps peak/brim/bill and is designed to house, protect, support the security technology device and provide user comfort.

3. A Security Technology device according to claim 1 can be used for personal use such as walking, jogging, biking, hiking, running errands and any outdoor activity that brings concern and will enhance your personal safety with rear vision.

4. A Security Technology device according to claim 1 can be used in professional industries such as Security, Law Enforcement, Military, Transportation and Construction and any professional outdoor activity that brings concern and will enhance your personal safety with rear vision.

5. A Security Technology device according to claim 1 that captures real time video images on a memory card in the event you want to file a police report.

6. A Security Technology device according to claim 1 that will change the way people look at and respond to their own personal security.

7. A Security Technology device according to claim 1 when used properly will expose and limit the element of surprise attacks giving people the advantage to monitor and conspicuously judge the situation, respond to it quickly and appropriately while lessening their chance of becoming a victim and captures real time video images in the event people want to file a police report.

8. A Security Technology device according to claim 1 that works with normal vision which allows you to see what's in front of you and peripherally and by wearing this device you could have total vision at 360 degrees facing forward.

9. A Security Technology device according to claim 1 that allows time for you to act on what you can see coming whether it's fight or flight when armed with pepper spray, or your safety product of choice.

10. A Security Technology device according to claim 1, that gives people the ability to take control of their own personal safety with a 180 degree rear view vision while facing forward.
